(19) United States
(12) Patent Application Publication
(10) Pub. No.: US 2011/0239039 A1
(43) Pub. Date: Sep. 29, 2011

(54) Cloud computing enabled robust initialization and recovery of it services

(76) Inventors: Devon C. Dieffenbach, Douglasville, GA (US); Joel B. Wall, Winston, GA (US); Robert T. Burke, JR., Atlanta, GA (US); Jared Max Gross, Atlanta, GA (US)

(21) Appl. No.: 12/661,932

(22) Filed: Mar. 26, 2010

(51) Int. Cl. G06F 11/30; G06F 15/177; G06F 15/173

(52) U.S. Cl. 714/4.1; 709/222; 709/221; 709/224; 714/E11.179

(57) ABSTRACT

A system and a method for provisioning of Information Technology (IT) services to a plurality of computers is provided. The system includes a network and transport device and local IT resources. The network and transport device has internet connectivity via a controlled switching interface. One or more of the computers are coupled to the network and transport device via the controlled switching interface. The local IT resources are also coupled to the one or more computers and include data storage and processing capability for providing IT services to the computers including server-based applications for utilization and operation by the computers. In addition, the local IT resources include a network and transport virtual machine generated as a virtual machine equivalent of the network and transport device and coupled to the controlled switching interface of the network and transport device for communication with the network and transport device.

### FIELD OF THE INVENTION

The present invention generally relates to cloud computing, and more particularly relates to a method and an apparatus for cloud computing enabled robust initialization and recovery of information technology (IT) services.

### BACKGROUND OF THE DISCLOSURE

Cloud computing is a way of computing, via the internet, which shares computer resources across the internet instead of using software and/or storage on a local computer or local server. Typical cloud computing arrangements deliver common business applications online, the applications being stored remote from the user and accessed from a web browser. Utilization of such remote applications typically includes a timelag for data and instructions to travel back and forth across the internet.

Information Technology (IT) services are typically provided by hardwiring multiple computers to a local server, the multiple computers utilizing applications, storage and processing on the local server. The server hardware and software is setup and maintained by IT specialists. Either full-time IT specialists are on a company's payroll to address any server malfunctions or any computer to server dysfunction, or, when a server-related problem arises, an IT specialist must be called. Such IT service problems are costly and/or require problematic computer downtime to resolve, particularly for small- to medium-sized businesses.

A cloud computing IT solution has been proposed which would have the IT infrastructure for a company handled remotely via cloud computing. This private cloud computing service would have typical server-based functionality (e.g., applications, data storage) hosted on a remote server.

In addition, conventional public cloud computing services have been proposed, such as Amazon S3. The public cloud computing services have not only the timelag issues associated with cloud computing, but also security and reliability issues. Security issues arise from having many companies' data co-stored in common storage without ample separation. In addition, adding public cloud computing customers, adding and/or updating significant amounts of data of current public cloud computing customers and general maintenance and expansion of the public cloud computing services result in uptime reliability issues.

Thus, what is needed is a method and apparatus for providing cloud computing enabled IT services which overcomes the reliability, security and timelag issues described above. Furthermore, other desirable features and characteristics will become apparent from the subsequent detailed description and the appended claims, taken in conjunction with the accompanying drawings and this background of the disclosure.

### SUMMARY OF THE INVENTION

According to the Detailed Description, a system is provided for provisioning of Information Technology (IT) services to a plurality of computers. The system includes a network and transport device and local IT resources. The network and transport device has interne connectivity via a controlled switching interface and is coupled to one or more of the plurality of computers via the controlled switching interface. The local IT resources are also coupled to the one or more computers and include data storage and processing capability for providing IT services to the one or more computers including server-based applications for utilization and operation by the one or more computers. In addition, the local IT resources include a network and transport virtual machine generated as a virtual machine equivalent of the network and transport device and coupled to the controlled switching interface for communication with the network and transport device.

In addition, a method is provided for initialization of IT services in a system for provision of IT services, the system including local IT resources and remote IT resources coupled together in a cloud computing environment. The method includes coupling one or more computers in a local network to a network and transport device including a controlled switching interface providing interne connectivity and coupling the network and transport device to the local IT resources for provision of the IT services to the one or more computers. The method also includes autoprovisioning the remote IT resources by configuring the remote IT resources in response to current network set parameters forwarded to the remote IT resources via the virtual machine controller.

Further, a method is also provided for recovery of IT services in a cloud computing environment enabled system for provision of the IT services to one or more computers, the system including local IT resources and remote IT services coupled together across the cloud computing environment. The method includes a network and transport device monitoring the operation of a network and transport virtual machine enabled in the local IT resources. When the network and transport device determines failure of the local IT resources in response to the operation of the network and transport virtual machine, the network and transport device changes an interne protocol (IP) configuration of the one or more computers, thereby rerouting the one or more computers to couple to the remote IT services for recovery of the IT services provided thereto.

### BRIEF DESCRIPTION OF THE DRAWINGS

The accompanying figures where like reference numerals refer to identical or functionally similar elements throughout the separate views and which together with the detailed description below are incorporated in and form part of the specification, serve to illustrate various embodiments and to explain various principles and advantages in accordance with the present invention.

FIG. 1 is a block diagram of information technology (IT) services provided in a cloud computing environment in accordance with a present embodiment;

FIG. 2 is a flow diagram of initialization of the IT services of FIG. 1 in accordance with the present embodiment; and

FIG. 3 is a flow diagram of automatic recovery of IT services in response to loss of local IT services of FIG. 1 in accordance with the present embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

The following detailed description of the invention is merely exemplary in nature and is not intended to limit the invention or the application and uses of the invention. Furthermore, there is no intention to be bound by any theory presented in the preceding background of the invention or the following detailed description of the invention.

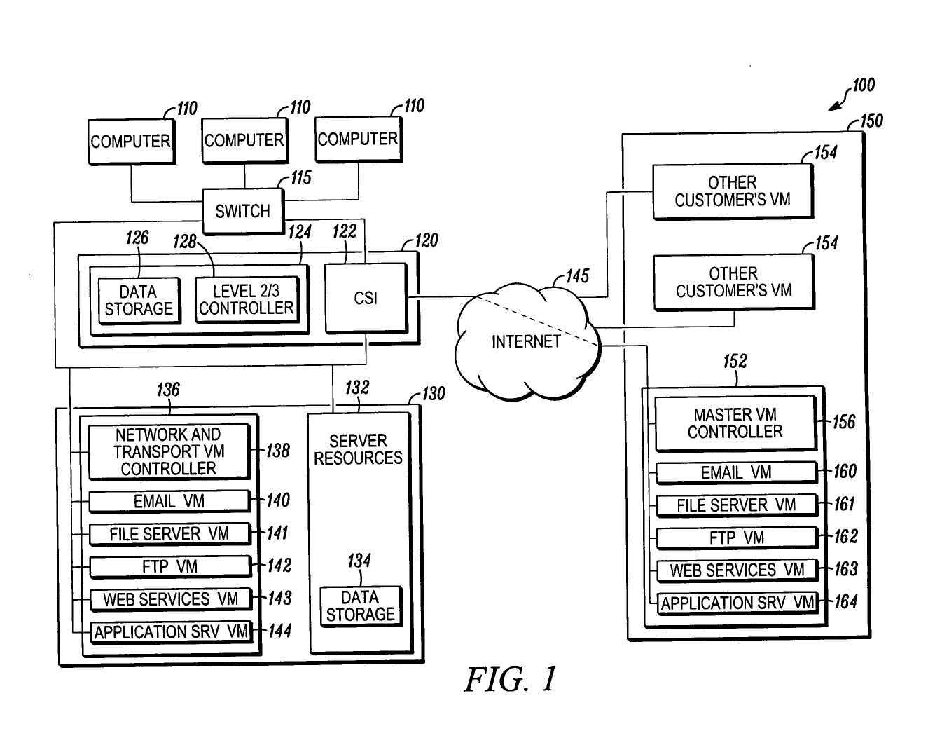

Referring to FIG. 1, a block diagram for a system 100 for providing information technology (IT) services to a plurality of computers 110 in a cloud computing environment is depicted. The computers 110 are coupled to a switch 115 in a local area network (LAN) arrangement in a manner familiar to those skilled in the art.

The system 100 also includes a network and transport device 120 and local IT resources 130. The network and transport device 120 has internet connectivity via a controlled switching interface 122 and is coupled to the switch 115 for providing internet connectivity to the computers 110, i.e., the computers 110 have access to the internet 145 via the controlled switching interface 122. The network and transport device 120 also includes computing resources 124, including data storage 126. The controlled switching interface 122 provides two abstraction levels of TCP/IP functionality for the computers 110, physical level and data level, and is switchable between the two levels. A level 2/3 controller 128 is enabled via the computing resources 124 and provides signaling to the controlled switching interface 122 for switching between the two levels of TCP/IP functionality. In addition, the controlled switching interface 122 is coupled to the computers 110 via the switch 115 for providing signaling to the computers 110 for reconfiguration in accordance with the present embodiment.

The local IT resources 130, which can be implemented in a single server or multiple intercoupled servers, are also coupled to the computers 110 via the switch 115 for defining the LAN for utilization by the computers 110 and coupled to the controlled switching interface 122 of the network and transport device 120. The local IT resources 130 include server resources 132 which include standard x86 or x64 processing capability and data storage 134 to provide processing and data storage capability for IT services to the computers 110, including server-based applications for utilization and operation by the computers 110.

The local IT resources 130 also include virtual machines 136 which include a network and transport virtual machine controller 138 generated as a virtual machine (VM) equivalent of the network and transport device 120. The network and transport virtual machine controller 138 is coupled to the controlled switching interface 122 for communication with the network and transport device 120. While having similar functionality, in accordance with the present embodiment, the network and transport virtual machine controller 138 and the network and transport device 120 operate in a master/slave fashion. The network and transport virtual machine controller 138 includes an application programming interface (API) configured in accordance with the present embodiment to set the configuration and functionality of the virtual machines 136 and the network and transport device 120. The virtual machines 136 also include a plurality of discrete virtual machines which are provisioned and configured for different system functions. The plurality of discrete virtual machines may include an email virtual machine 140, a file server virtual machine 141, a file transfer protocol (FTP) virtual machine 142, a web services virtual machine 143 or an application services virtual machine 144 or any other virtual machines. Since both the network and transport virtual machine controller 138 and the network and transport device 120 are coupled to the internet 145 via the controlled switching interface 122, the internet protocol (IP) address and the media access control (MAC) address of the network and transport virtual machine controller 138 and the network and transport device 120 can be configured to appear the same when accessed from the internet 145.

The cloud computing system 100 further includes cloud based server resources 150 coupled to the local IT resources 130 via the internet 145. The cloud based server resources 150 includes remote virtual machines 152 which are a virtual machine equivalent of the local IT resources 130. In addition to the remote virtual machines 152, the cloud based server resources 150 is capable of supporting and providing backup for other local IT resources (not shown) and, accordingly, may include other customer's remote virtual machines 154 which provide segregated processing and storage capability for local IT resources of the other customers.

The remote virtual machines 152 are defined upon initialization of the IT services and is expanded as needed in response to extra resources utilized by the local IT resources 130. The remote virtual machines 152 includes a master virtual machine (VM) controller 156 and a plurality of discrete virtual machines 160, 161, 162, 163 and 164 mirroring and backing up the discrete virtual machines 140, 141, 142, 143 and 144. The master VM controller 156 is coupled to the discrete virtual machines 160, 161, 162, 163, 164, and is selectively coupleable to the computers 110 through the controlled switching interface 122 of the network and transport device 120 for providing processing and data storage capability for IT services to the computers 110 when failure of the local IT resources 130 is detected by the network and transport device 120. In accordance with the present embodiment, provision of IT services for the computers 110 is transferred from the local IT resources 130 to the remote virtual machines 152 in response to the network and transport device 120 losing communication with the virtual machines 136.

Virtual IT resources of the remote virtual machines 152 are defined upon initialization of the IT services by autoprovisioning the virtual IT resources in response to provisioning of the local IT resources 130. For example, the virtual IT resources at the remote virtual machines 152 are autoprovisioned in response to one or both of predefined settings of the local IT resources 130 and network parameters utilized by the local IT resources 130. In addition, the system 100 further provides automatic physical to virtual provisioning of the IT services at the local IT resources 130 in order to provide the virtual IT services to the remote server.

After initialization, the virtual IT resources of the remote virtual machines 152 include replication of real time utilization of the local IT resources 130 by the computers 110, including duplication of applications, data, configuration and server-based utilization of the applications by the computers 110. In addition, the remote virtual machines 152 include duplicate remote data storage for duplicate storage of data stored in the data storage device 134. Secure data transference between the data storage device 134 and the duplicate remote data storage at the remote virtual machines 152 is controlled in response to secure encryption keys.

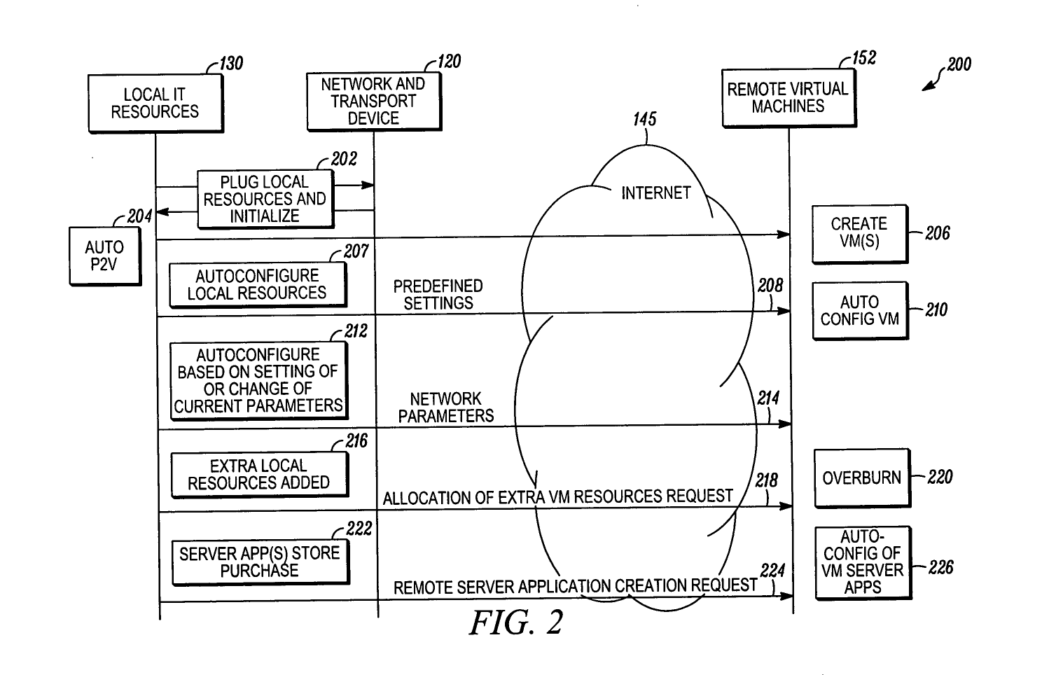

Referring to FIG. 2, a flow diagram 200 of initialization of the IT services in the cloud computing system 100 in accordance with the present embodiment is depicted. As described above, the system 100 includes the local IT resources 130 coupled through the network and transport device 120 and the internet 145 to the remote virtual machines 152. When establishing IT services, initially the computers 110 are coupled to the switch 115 which is coupled to the network and transport device 120 and the local IT resources 130. Then, the local IT resources 130 and the network and transport device 120 are coupled together, powered up and initialized 202. Next, the local IT resources 130 and the network and transport device 120 are coupled to the internet 145. The local IT resources 130 are automatically physical to virtual provisioned 204 (i.e., a virtual “copy” of the local IT resources 130 is created) and the virtual IT resources are forwarded 205 to the cloud based server resources 150 for creation 206 of the remote virtual machines 152, including configuration of the master VM controller 156. The local resources 130 are then autoconfigured 207 in response to configuration information received from the network and transport device 120. The local resources 130 provide predefined settings 208 to the master VM controller 156 via the internet 145 and the remote virtual machines 152 are autoconfigured 210 by the master VM controller 156 in response to the predefined settings. In addition to autoconfiguring 208 the remote virtual machines 152, autoprovisioning of the remote IT resources in accordance with the present embodiment reapportions the remote IT resources in the remote virtual machines 152 in accordance with the automatic physical to virtual machine process 204 defined by the network and transport virtual machine controller 138 in response to the local IT resources 130. During the course of operation of the system 100 in accordance with the present embodiment, as the settings of the local IT resources 130 are updated, the settings of the remote virtual machines 152 are automatically updated.

The local IT resources 130 also automatically configure themselves upon the setting of or in response to a change in current network set parameters thereof 212. Each time the network parameters of the local IT resources 130 are set or reconfigured, the remote virtual machines 152 are further updated by the master VM controller 156 receiving the current network set parameters 214 from the network and transport virtual machine controller 138 and configuring the remote virtual machines 152 in response to the current network set parameters. In addition, in order to provide secure transfer of and access to data, including transfer of the network parameters and other settings, a hardware encryption key provided to the local IT resources 130 (i.e., either manually entered upon system initialization or securely provided thereafter) is assigned via the network and transport virtual machine controller 138 to the master VM controller 156.

When extra local resources are added 216 at the local IT resources 130, an instruction, such as an allocation of extra virtual machine resources request, is forwarded 218 to the remote virtual machines 152. The remote virtual machines 152 then provisions extra cloud computing based resources 220 in response to the instruction from the local IT resources 130. The provisioning of the extra cloud computing based resources 220 may include overburn of the remote virtual machines 152 (increasing the computing resources of the remote virtual machines 152), thereby enabling a dynamic reassignment of computing resources for the local IT resources 130 within the cloud based server resources 150 by increasing the size of one or more of the discrete virtual machines 160, 161, 162, 163, 164 either temporarily or permanently.

During operation of the system 100, the local IT resources 130 can add server and/or storage applications 222. In order to maintain a mirrored virtual server at the remote virtual machines 152, the local IT resources, after adding the server or storage applications 222, forwards a remote server application creation request 224 to the remote virtual machines 152. In this manner, configuration data is forwarded to the master VM controller 156 for creation and autoconfiguration of applications 226 onto one or more of the discrete virtual machines 160, 161, 162, 163, 164 in response to server applications resident on and added to discrete virtual machines 140, 141, 142, 143, 144 of the local IT resources 130.

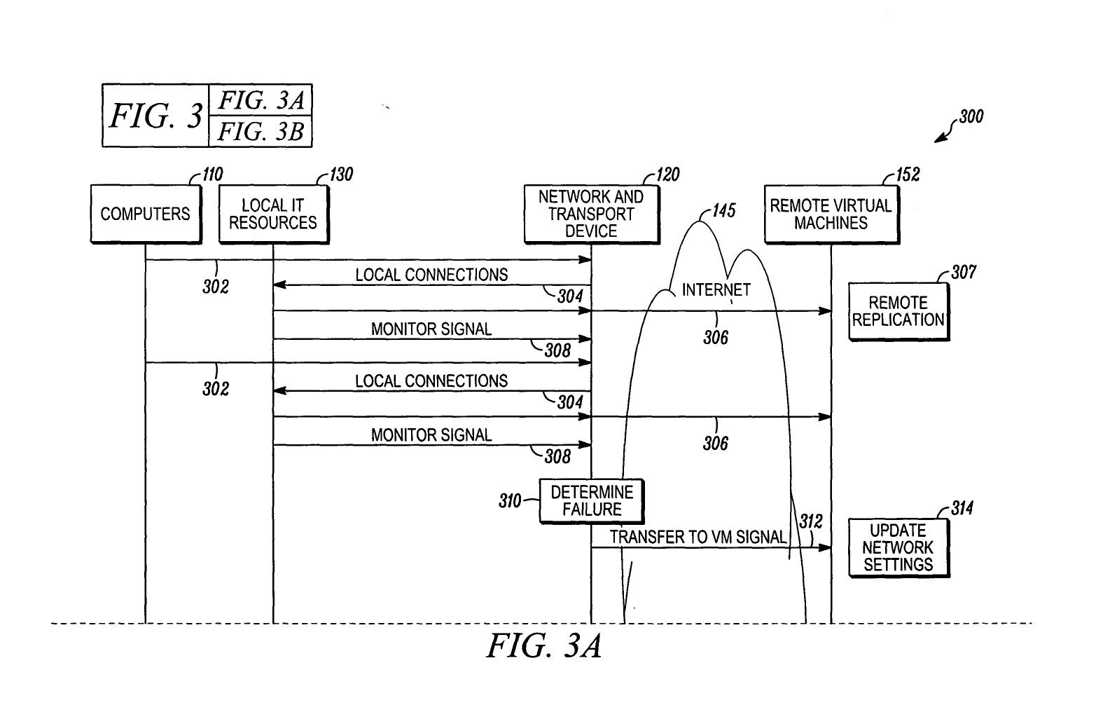

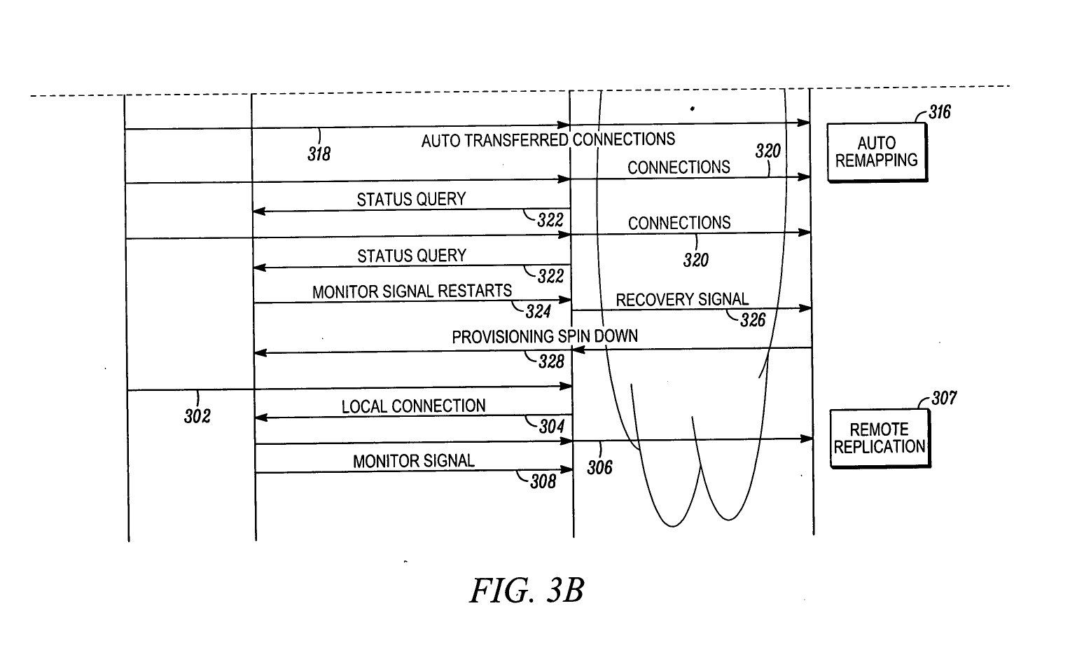

Referring to FIG. 3, a flow diagram 300 depicts normal operation and automatic recovery of IT services in response to a loss of the local IT resources 130 in accordance with the present embodiment. During normal operation, local connections 302, 304 are established and maintained between the computers 110 and the local IT resources 130 via the controlled switching interface 122 through the switch 115. As the computing resources (e.g., the processing and/or data storage) of the local IT resources 130 are modified, the local IT resources 130 forwards instructions 306 to the master VM controller 156 at the remote virtual machines 152 to mirror the modifications therein by remote replication 307 of the modifications at the discrete virtual machines 160, 161, 162, 163, 164. The data and instructions transferred between the network and transport virtual machine controller 138 and the master VM controller 156 are protected by data encryption keys to ensure the security of the data transference. In accordance with the present embodiment, a monitor signal is forwarded 308 from the network and transport virtual machine controller 138 to the network and transport device 120 to verify that operation of the local IT resources 130 is functioning normally.

The network and transport device 120 utilizes reception 308 of the monitor signal from the network and transport virtual machine controller 138 to determine functioning of the local IT resources 130. The network and transport device 120 determines failure 310 of the local IT resources 130 in response to loss of the monitor signal 308 (i.e., failure to receive the monitor signal 308). As stated above, the network and transport virtual machine 136 of the local IT resources 130 and the network and transport device 120 operate in a master/slave relationship. In response to failure 310 of the local IT resources 130, the network and transport device 120 takes over the function of the network and transport virtual machine 136 and transfers information 312 to the master VM controller 156 for recovery of the IT services. The master VM controller 156 utilizes the information 312 to update network settings 314 and to automatically remap 316 to the remote virtual machines 152 a local network, such as a virtual private network (VPN), defined by the local IT resources 130 for utilization by the computers 110. In addition, the network and transport device 120 forwards information to the computers 110 to change the interne protocol (IP) configuration of the computers 110 to reroute the computers 110 to couple to the network and transport device 120 for access to the remote virtual machines 152 for provision of the IT services.

During operation, to ensure a seamless transfer of IT services from the local IT resources 130 to the remote virtual machines 152, the network and transport device 120 stores configuration settings as utilized by the local IT resources 130 in the data storage 126. When the network and transport device 120 determines failure of the local IT resources 130, the network and transport device 120 forwards the stored configuration settings to the master VM controller 156. The master VM controller 156, upon being informed that the local IT resources 130 have failed by the information 312 spins up the discrete virtual machines 160, 161, 162, 163, 164 for provision of IT services for the computers 110. Prior to spin up, the discrete virtual machines 160, 161, 162, 163, 164 exist only as storage data. The master VM controller 156, when spinning up the discrete virtual machines 160, 161, 162, 163, 164, allocates computing resources for each of the discrete virtual machines 160, 161, 162, 163, 164 for activation thereof. The master VM controller 156 updates the configuration settings of the discrete virtual machines 160, 161, 162, 163, 164 in response to the stored configuration settings utilized by the local IT resources 130 and forwarded 312 by the network and transport device 120. Further, in accordance with the present embodiment, the master VM controller 156 reassigns one or more predetermined domain name system (DNS) identifiers assigned to the local IT resources 130 to the remote virtual machine when the network and transport device 120 determines failure of the local IT resources 130.

The network and transport device 120 then couples the computers 110 to the master VM controller 156 for provision of the IT services from the remote virtual machines 152, the network and transport device 120 establishing the connections 318 between the computers 110 and the master VM controller 156 for provision of IT services. In this manner, the remote virtual machines 152 thereafter host server-based applications for the computers 110. Operation then proceeds in a recovery mode in accordance with the present embodiment wherein connections 320 are maintained between the computers 110 and the master VM controller 156 via the network and transport device 120 for provision of IT services. In addition, the network and transport device 120 periodically sends a status query 322 to the network and transport virtual machine controller 138 to determine if the local IT resources 130 have recovered.

When a status reply signal 324 is received by the network and transport device 120 from the network and transport virtual machine controller 138, the network and transport device 120 communicates this change in status to the master VM controller 156 by sending a recovery signal 326. Then, in a provisioning spin down, the master VM controller 156 forwards configuration and network settings 328 to the local IT resources 130 and deactivates the discrete virtual machines 160, 161, 162, 163, 164. Once provisioned, the local IT resources 130 communicate a recovery signal 330 to the network and transport device 120, which then decouples the computers 110 from the master VM controller 156 and couples them to the local IT resources 130, thereby re-establishing the normal operation connections 302.

Thus it can be seen that a method and apparatus have been disclosed which advantageously provides a robust system 100 for initialization and provision of IT services which overcomes the reliability, security and timelag issues of previous cloud computing enabled systems providing IT services. The system 100 in accordance with the present embodiment provides quick, simple, and inexpensive initialization and setup which requires only a small amount of professional IT personnel assistance. The timelag issues are minimized by the use of local IT resources 130 for the provision of IT services. Reliability of the provision of IT services is provided by automatic recovery from failure of the local IT resources 130 in accordance with the present embodiment through quick and secure engagement of a portion of the remote server resources 150 to maintain IT services, thereby providing robust cloud computing enabled IT services. While at least one exemplary embodiment has been presented in the foregoing detailed description of the invention, it should be appreciated that a vast number of variations exist, including a vast number of acceptable dimensions. In addition, in this document, the terms “includes”, “including”, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “includes . . . a” does not, without more constraints, preclude the existence of additional identical elements in the process, method, article, or apparatus that comprises the element.

It should further be appreciated that the exemplary embodiment is only an example, and is not intended to limit the scope, applicability, dimensions, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

What is claimed is:

1. A system for provision of Information Technology (IT) services to a plurality of computers, the system comprising:
a network and transport device having interne connectivity via a controlled switching interface thereof, the network and transport device coupled to one or more computers of the plurality of computers via the controlled switching interface; and
local IT resources also coupled to the one or more computers and comprising data storage and processing capability for providing IT services to the one or more computers including server-based applications for utilization and operation by the one or more computers, the local IT resources comprising a network and transport virtual machine generated as a virtual machine equivalent of the network and transport device and coupled to the controlled switching interface for communication therewith.

2. The system in accordance with claim 1 further comprising a remote server comprising a remote virtual machine equivalent of the local IT resources, wherein the remote virtual machine is defined upon initialization of the IT services and is selectively coupleable to the one or more computers through the network and transport device.

3. The system in accordance with claim 2, wherein the remote virtual machine comprises virtual IT resources which, after being defined upon initialization of the IT services, are autoprovisioned in response to provisioning of the local IT resources, wherein information for autoprovisioning the remote virtual machine is generated by automatic physical to virtual provisioning of the IT services at the local IT resources.

4. The system in accordance with claim 3 wherein the virtual IT resources are autoprovisioned in response to one or both of predefined settings of the local IT resources and network parameters utilized by the local IT resources.

5. The system in accordance with claim 3 wherein the virtual IT resources are expanded as needed in response to extra resources utilized by the local IT resources.

6. The system in accordance with claim 2, wherein the virtual IT resources comprise replication of real time utilization of the local IT resources by the one or more computers, including duplication of applications, data, configuration and server-based utilization of the applications by the one or more computers.

7. The system in accordance with claim 2, wherein the local IT resources comprise local data storage and wherein the virtual IT resources comprise duplicate remote data storage, and wherein data transference between the local data storage and the duplicate remote data storage is controlled in response to secure encryption keys.

8. The system in accordance with claim 2, wherein provision of the IT services for the one or more computers is transferred from the local IT resources to the remote virtual machine in response to the network and transport device losing communication with the network and transport virtual machine.

9. A method for initialization of Information Technology (IT) services in a system for provision of IT services including local IT resources and remote IT resources coupled together in a cloud computing environment, the method comprising:
coupling one or more computers in a local network to a network and transport device including a controlled switching interface providing interne connectivity;
coupling the network and transport device to the local IT resources for provision of the IT services to the one or more computers; and
autoprovisioning the remote IT resources by configuring the remote IT resources in response to current network set parameters forwarded to the remote IT resources by a virtual machine controller.

10. The method in accordance with claim 9, further comprising the step of thereafter updating the remote IT resources in response to updated settings of the local IT resources forwarded from the virtual machine controller to the remote IT resources via the controlled switching interface after automatic physical to virtual provisioning of the updated settings at the local IT resources.

11. The method in accordance with claim 10, wherein the step of updating the remote IT resources comprises the step of reapportioning the remote IT resources in response to the updated settings.

12. The method in accordance with claim 11, wherein the step of reapportioning the remote IT resources comprises the step of provisioning extra cloud computing based resources in response to the updated settings of the local IT resources.

13. The method in accordance with claim 9, wherein the step of autoprovisioning the remote IT resources comprises creation and autoconfiguration of the remote IT resources in response to server applications resident on and added to the local IT resources.

14. The method in accordance with claim 9, wherein the step of autoprovisioning the remote IT resources comprises:
dynamically encapsulating data storage for the local IT resources within cloud based server resources; and
assigning a hardware encryption key from the virtual machine controller to an application programming interface of the remote IT resources for secure access to the data storage.

15. A method for recovery of Information Technology (IT) services in a cloud computing environment enabled system for provision of the IT services to one or more computers, the system including local IT resources and remote IT services coupled together across the cloud computing environment, the method including:
a network and transport device monitoring the operation of a network and transport virtual machine enabled in the local IT resources;
the network and transport device determining failure of the local IT resources in response to the operation of the network and transport virtual machine; and
the network and transport device changing an interne protocol (IP) configuration of the one or more computers, thereby rerouting the one or more computers to couple to the remote IT services for recovery of the IT services provided thereto.

16. The method in accordance with claim 15 wherein the step of changing the IP configuration of the one or more computers comprises the remote IT services thereafter hosting server-based applications for the one or more computers.

17. The method in accordance with claim 15 wherein the step of changing the IP configuration of the one or more computers comprises the network and transport device changing the IP configuration of the one or more computers to reroute the one or more computers to couple to a controlled switching interface of the network and transport device coupleable to the remote IT services for recovery of the IT services provided to the one or more computers.

18. The method in accordance with claim 15 wherein the step of monitoring the operation of the network and transport virtual machine comprises the network and transport device storing configuration settings as utilized by the local IT resources, the method further comprising the step of updating configuration settings of the remote IT services in response to the stored configuration settings utilized by the local IT resources when the network and transport device determines failure of the local IT resources.

19. The method in accordance with claim 15 wherein one or more predetermined domain name system (DNS) identifiers are assigned to the local IT resources, and wherein the method further comprises the step of a master virtual machine controller of the remote IT services reassigning the one or more predetermined DNS identifiers from the local IT resources to the remote IT services when the network and transport device determines failure of the local IT resources.

20. The method in accordance with claim 15 wherein the step of changing the IP configuration of the one or more computers comprises the network and transport device automatically remapping to the remote IT services a local network defined by the local IT services for utilization by the one or more computers.
